(19) United States
(12) Patent Application Publication
(10) Pub. No.: US 2008/0225939 A1
(43) Pub. Date: Sep. 18, 2008

(54) MULTIFUNCTIONAL VIDEO ENCODING CIRCUIT SYSTEM

(76) Inventors: JIUN-IN GUO, Chiayi County (TW); KUAN-HUNG CHEN, Dalin Township (TW); JINN-SHYAN WANG, Chiayi City (TW); YU-MIN CHEN, Cigu Township (TW); YUAN-SUN CHU, Chiayi County (TW)

Correspondence Address: SCHMEISER, OLSEN & WATTS, 22 CENTURY HILL DRIVE, SUITE 302, LATHAM, NY, 12110, US

(21) Appl. No.: 11/686,571

(22) Filed: Mar. 15, 2007

(51) Int. Cl. H04B 1/66

(52) U.S. Cl. 375/240.01; 708/620

(57) ABSTRACT

The present invention discloses a multifunctional video encoding circuit system capable of performing six types of operations: addition, subtraction, multiplication, multiply-accumulation, interpolation, and absolute difference summation. A partial product generation part, a partial product reduction part and an accumulation part of the circuit system are equipped with a virtual power suppression unit each for reducing the power consumption of the partial product generation part, the partial product reduction part and the accumulation part, so as to reduce the power consumption of the multifunctional video encoding circuit system.

### FIELD OF THE INVENTION

The present invention relates to a multifunctional video encoding circuit system, and more particularly to a multifunctional video encoding circuit system capable of reducing the power consumption of a partial product generation part, a partial product reduction part and an accumulation part by a virtual power suppression unit, and further reducing the power consumption of the multifunctional video encoding circuit system.

### BACKGROUND OF THE INVENTION

In recent years, integrated circuit designers invested tremendous time and effort on reducing the power consumption while maintaining the original computation efficiency of an integrated circuit system, e.g. a video encoding circuit system. Partial products of a multiplier can mainly be added by column-wise addition or row-wise addition. Conventional multipliers such as Wallace or Dadda multipliers generally adopt the column-wise addition, but the multipliers of this sort consume more power consumption than the multipliers that adopt the row-wise addition. In addition, existing multipliers generally perform an exhaustive operation, but the valid data widths of an operation are not always equal to the maximum data widths of the hardware in practical applications. Thus, the functional unit will perform unnecessary computations and waste lots of power. Further, the multiplication conducted in practical applications must work together with other types of computations such as addition, subtraction and multiply-accumulation to complete the required operations. However, the functional units of a microprocessor generally come with a single function, and thus it is not easy to allocate the hardware resource efficiently. As a result, some functional units are very busy, while other functional units are idle.

Therefore, it is a subject for the present invention to explore and develop a multifunctional video encoding circuit system with multiple types of computational functions to enhance the flexibility of allocating the hardware resource as well as to reduce the dynamic power consumption of a circuit.

### SUMMARY OF THE INVENTION

In view of the shortcomings of the prior art, the inventor of the present invention based on years of experience in the related industry to conduct researches and experiments, and finally developed a multifunctional video encoding circuit system with multiple types of computational functions to enhance the flexibility of allocating the hardware resource. By operating with a virtual power suppression unit, the dynamic power consumption of a circuit can be reduced so as to further achieve the objective of reducing the power consumption of the multifunctional video encoding circuit system.

Therefore, it is a primary objective of the present invention to provide a multifunctional video encoding circuit system, wherein a partial product generation part, a partial product reduction part and an accumulation part are equipped with a virtual power suppression unit each, and these virtual power suppression units reduce the power consumption of the partial product generation part, the partial product reduction part and the accumulation part, and further reduce the power consumption of the multifunctional video encoding circuit system.

Another objective of the present invention is to provide a multifunctional video encoding circuit system, comprising: a partial product generation part that performs a modified booth encoding computation for a plurality of video computing data to generate a plurality of partial product values; a partial product reduction part that adds the partial product values to generate a plurality of first results; and an accumulation part that accumulates the first results to generate a second result.

In addition, these virtual power suppression units reduce the power consumption of the partial product generation part, the partial product reduction part and the accumulation part, and further achieve the objective of reducing the power consumption of the multifunctional video encoding circuit system.

The above and other objects, features and advantages of the present invention will become apparent from the following detailed description taken with the accompanying drawing.

### BRIEF DESCRIPTION OF THE DRAWINGS

FIG. 1 is a flow chart of a modified booth multiplication method in accordance with a preferred embodiment of the present invention;

FIG. 2 is a circuit block diagram of a preferred embodiment of the present invention;

FIG. 3 is a circuit block diagram of a SPST modified booth encoder in accordance with a preferred embodiment of the present invention;

FIG. 4 is a circuit block diagram of a partial product reduction part in accordance with a preferred embodiment of the present invention;

FIG. 5 is a circuit block diagram of an accumulation part in accordance with a preferred embodiment of the present invention;

FIG. 6 is an internal circuit block diagram of a virtual power suppression unit as depicted in FIG. 4;

FIG. 7 is an internal circuit block diagram of a detection logic circuit as depicted in FIG. 6;

FIG. 8 is a timing diagram of a detection logic circuit as depicted in FIG. 7;

FIG. 9 is an internal circuit block diagram of a data latch as depicted in FIG. 6;

FIG. 10 is an internal circuit block diagram of a sign-extension circuit as depicted in FIG. 6;

FIG. 11 is a schematic view of another preferred embodiment of a detection logic circuit as depicted in FIG. 7;

FIG. 12 is a timing diagram of a detection logic circuit as depicted in FIG. 11; and

FIG. 13 is a circuit block diagram of a multifunctional video encoding circuit system applied to a processor in accordance with the present invention.

### DETAILED DESCRIPTION OF THE PREFERRED EMBODIMENTS

To make it easier for our examiner to understand the objective, innovative features and performance of the present invention, we use preferred embodiments and accompanying drawings for a detailed description of the present invention.

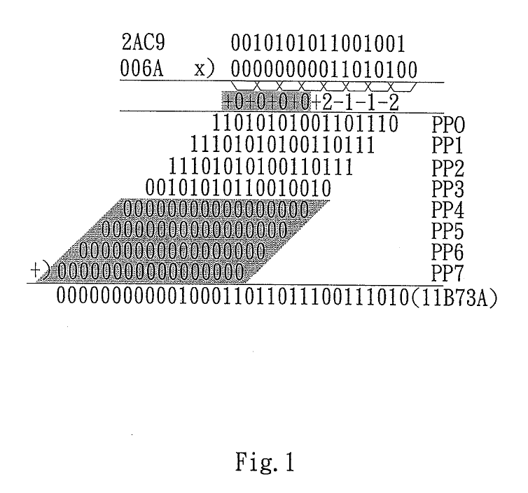

Referring to FIG. 1 for a flow chart of a computation of a partial product generation part in accordance with a preferred embodiment of the present invention, the partial product generation part is a modified booth encoder, and the decoding principle is described as follows:

2^{a}=2^{a+1}−2^{a}

For an n-bit multiplicator, the encoding of the modified booth encoder is derived below:

$$\begin{matrix}Y = - {y}_{n - 1} {2}^{n - 1} + {y}_{n - 2} {2}^{n - 2} + … + {y}_{1} {2}^{1} + {y}_{0} {2}^{0} \\ = - {y}_{n - 1} {2}^{n - 1} + {y}_{n - 2} ( {2}^{n - 1} - {2}^{n - 2} ) + … + \\ {y}_{1} ( {2}^{2} - {2}^{1} ) + {y}_{0} ( {2}^{1} - {2}^{0} ) \\ = ( {y}_{n - 2} - {y}_{n - 1} ) {2}^{n - 1} + ( {y}_{n - 3} - {y}_{n - 2} ) {2}^{n - 2} + … + \\ ( {y}_{0} - {y}_{1} ) {2}^{1} + ( {y}_{- 1} - {y}_{0} ) {2}^{0} ; {y}_{- 1} = 0 \\ = ( {y}_{n - 3} + {y}_{n - 2} - 2 {y}_{n - 1} ) {2}^{n - 2} + ( {y}_{n - 4} + {y}_{n - 3} - 2 {y}_{n - 2} ) {2}^{n - 3} + … + \\ ( {y}_{- 1} + {y}_{0} - 2 {y}_{1} ) {2}^{0} \\ = {\sum }_{i = 0}^{n} ( {y}_{2 i - 1} + {y}_{2 i} - 2 {y}_{2 i + 1} ) \cdot {2}^{2 i}\end{matrix}$$

Then 2AC9₁₆×006A₁₆ is used as an example of the operation as illustrated in FIG. 1, and one of the operators 006A₁₆ is encoded by the modified booth encoder, and the number of partial products drops from 16 to 8, and the complexity of the computation will be simplified and reduced by a half. Finally, the result of the multiplication operation can be obtained by adding the partial products.

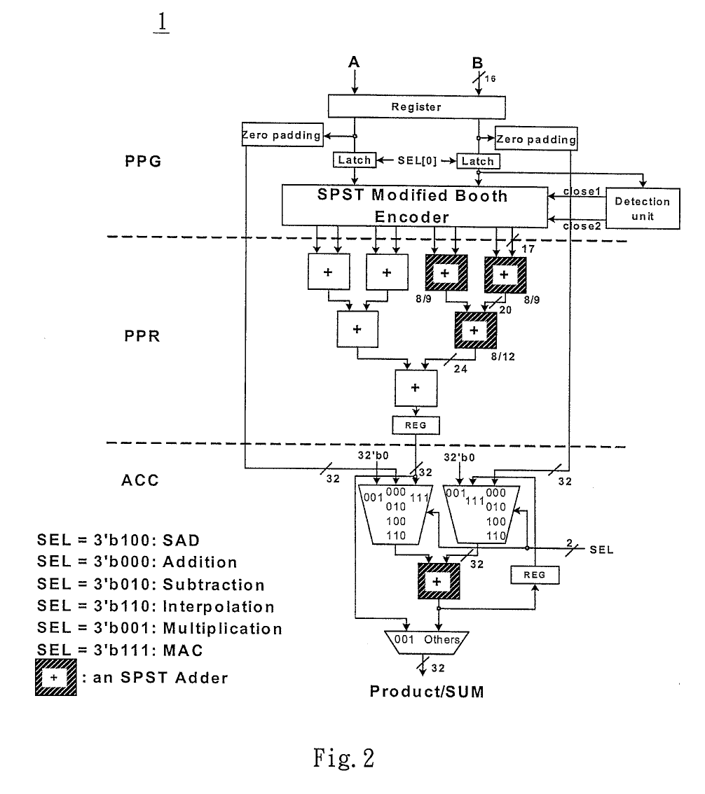

Referring to FIG. 2 for a circuit block diagram of a preferred embodiment of the present invention, a multifunctional video encoding circuit system 1 integrates addition, subtraction, multiplication, multiply-accumulation, interpolation and absolute difference summation into a computation unit, such that these arithmetic operations can share the same hardware resource to save costs, and the multifunctional video encoding circuit system 1 comprises: a partial product generation part PPG that performs a modified booth encoding computation for a plurality of video computing data to generate a plurality of partial product values, wherein the partial product generation part PPG includes a virtual power suppression unit for reducing the power consumption of the partial product generation part PPG; a partial product reduction part PPR that adds the partial product values to generate a plurality of first results, wherein the partial product reduction part PPR includes a virtual power suppression unit for reducing the power consumption of the partial product reduction part PPR; and an accumulation part ACC that accumulates the first results to generate a second result. The accumulation part ACC includes a virtual power suppression unit for reducing the power consumption of the accumulation part ACC; a SPST modified booth encoder installed at the partial product generation part PPG can turn off unused extra partial product circuits automatically, and the multifunctional video encoding circuit system 1 can select a required operation from six types of arithmetic operations provided by a control signal SEL. The multifunctional video encoding circuit system 1 further comprises a plurality of first multiplexers, each for selecting an operation path of the video computing data, and the partial product generation part comprises a plurality of data latches of a plurality of second multiplexers for latching the second multiplexers.

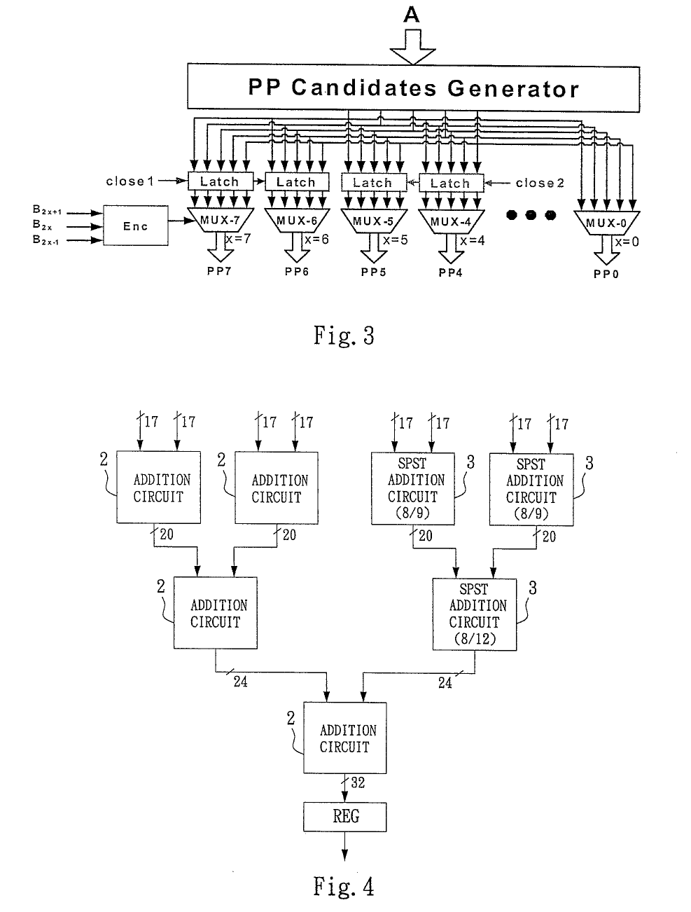

Referring to FIG. 3 for a circuit block diagram of a SPST modified booth encoder in accordance with a preferred embodiment of the present invention, a data latch can latch a partial circuit. For example, if the partial products PP4˜PP7 are zero, the data latch will latch the input data of the second multiplexers MUX-4˜MUX-7. If the partial products PP6˜PP7 are zero, then the data latch will only latch the input data of the second multiplexers MUX-6˜MUX-7 to save power consumption.

Referring to FIG. 4 for a circuit block diagram of a partial product reduction part in accordance with a preferred embodiment of the present invention, the partial product reduction part PPR is comprised of a plurality of addition circuits 2 and a plurality of SPST addition circuits 3, and the data width of the most significant part and the least significant part are represented by a numerator and a denominator of a fraction in the SPST addition circuit 3 respectively.

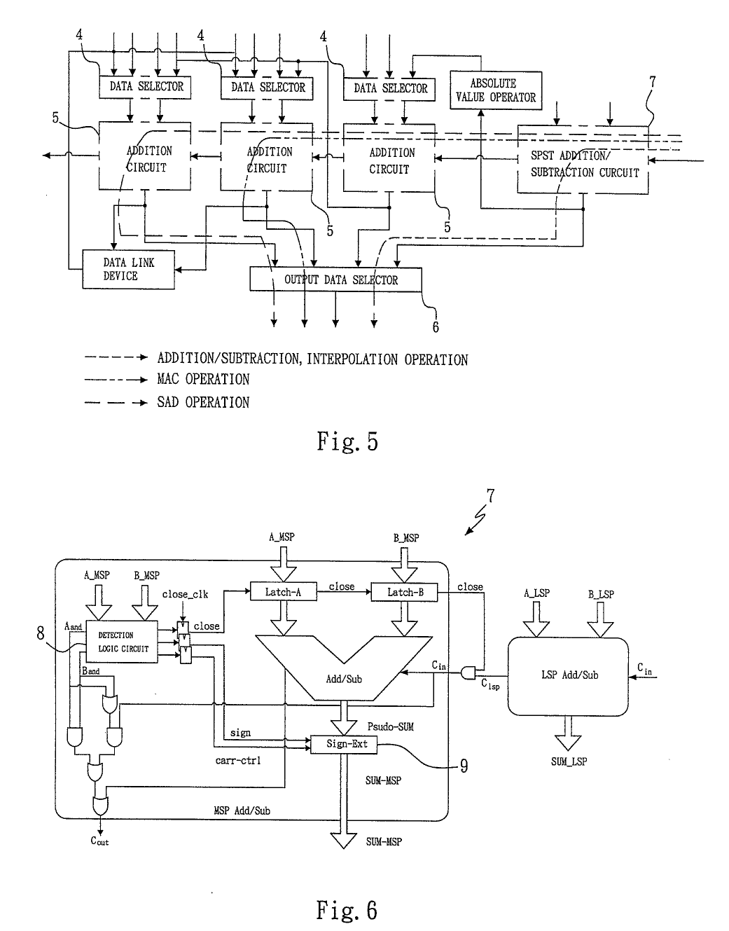

Referring to FIG. 5 is a circuit block diagram of an accumulation part in accordance with a preferred embodiment of the present invention, the accumulation part ACC comprises: a plurality of data selectors 4, each for receiving the partial product values; a plurality of addition circuits 5, each for receiving the partial product values from the data selector 4; an output data selector 6, coupled to the addition circuit 5 and an addition/subtraction circuit having the virtual power suppression unit 7, for generating the second result, wherein the five types of operations: multiply-accumulation, addition, subtraction, interpolation and absolute difference summation share the adder of the accumulation part ACC, and the data path of each operation is also shown in FIG. 5.

The multifunctional video encoding circuit system guides the video computing data through an appropriate path by a control circuit. In other words, the path of the video computing data varies with the selected function, and the arithmetic operations for different functions are completed. The multifunctional switch of the multifunctional video encoding circuit system takes the low power design into consideration. After the required operation is selected, the control circuit will guide the video computing data through an appropriate path to complete the selected operation without toggling the dynamic activities in the partial circuit, so as to avoid unnecessary dynamic power consumption. Since the dynamic power consumption occupies approximately 80% of the total power consumption in a CMOS circuit, therefore this low dynamic power design is very important for the design of a multifunctional circuit.

Since the data processed by video encoding refers to the difference value between frames, the numeric values of most video computing data use the data width of the least significant part only. In other words, the absolute value of these video computing data is usually much smaller than the maximum. However, the hardware architecture still needs a bandwidth capable of processing the data of the maximum width to maintain the precision of the operation, and thus a circuit often executes unnecessary operations and results in unnecessary power consumption. For example, it is known from an operation of 16-bit multiplication that if the effective range of one of the operators is within the least significant part, the value of the most significant part after the booth encoding is equal to 0, the partial product as shown in the shaded portion in FIG. 1 will be equal to 0, and the operations by the modified booth encoder of the most significant part and the partial product reduction part can be skipped to save power consumption. Therefore, we can divide the arithmetic circuit into a least significant part circuit and a most significant part circuit. To determine whether or not to enable the most significant part circuit, we need a detection logic circuit to determine the effective range of the input data, and its operation principle is described as follows:

A_{MSP}=A[15:8]; B_{MSP}=B[15:8]

A_{and}=A[15]·A[14]· . . . ·A[8]

B_{and}=B[15]·B[14]· . . . ·B[8]

Aₙₒᵣ= A̅[̅1̅5̅]̅+̅A̅[̅1̅4̅]̅+̅ .̅ .̅ .̅ +̅A̅[̅8̅]̅

Bₙₒᵣ= B̅[̅1̅5̅]̅+̅B̅[̅1̅4̅]̅+̅ .̅ .̅ .̅ +̅B̅[̅8̅]̅

close=(A_{and}+Aₙₒᵣ)·(B_{and}+Bₙₒᵣ);

Where, A[m] and B[n] stand for the m^{th} bit of Operator A and the n^{th} bit of Operator B, and A_{MSP} and B_{MSP} stand for the most significant parts of Operator A and Operator B, respectively. If all bits of the most significant parts of Operator A or Operator B are equal to 1, then the values of A_{and} or B_{and} will be equal to 1; if all bits of the most significant part of Operator A or Operator B are equal to 0, then the value of Aₙₒᵣ or Bₙₒᵣ will be equal to 1. The “close” signal, one of the three output signals of the detection logic circuit, will determine whether or not to close the most significant part circuit. If the most significant parts of Operators A and B do not affect the computation result, then the signal “close” will become 0 to close the most significant part circuit to save power consumption. When the most significant part circuit is closed, we can use a data latch to latch the original most significant bit data, and input 0 to the most significant part circuit to stop all phase changing activities so as to prevent a drop of electric potential due to a long time of floating, compared with using transmission gate to latch the data. The Boolean logic equations of another two output signals: carr-ctrl and sign of the detection logic circuit are given below.

$$\begin{matrix}carr \text{-} ctrl = \overline{{C}_{LSP}} \cdot \overline{{A}_{and}} \cdot {A}_{nor} \cdot {B}_{and} \cdot \overline{{B}_{nor}} + \\ \overline{{C}_{LSP}} \cdot {A}_{and} \cdot \overline{{A}_{nor}} \cdot \overline{{B}_{and}} \cdot {B}_{nor} + {C}_{LSP} \cdot \overline{{A}_{and}} \cdot {A}_{nor} \cdot \\ \overline{{B}_{and}} \cdot {B}_{nor} + {C}_{LSP} \cdot {A}_{and} \cdot \overline{{A}_{nor}} \cdot {B}_{and} \cdot \overline{{B}_{nor}} \\ = \overline{{C}_{LSP}} \cdot ( \overline{{A}_{and}} \cdot {B}_{and} + {A}_{and} \cdot \overline{{B}_{and}} ) \cdot ( {A}_{and} \cdot {B}_{and} + \\ {A}_{and} \cdot {B}_{nor} + {A}_{nor} \cdot {B}_{and} + {A}_{nor} \cdot {B}_{nor} ) + \\ {C}_{LSP} \cdot ( {A}_{and} \cdot {B}_{and} + \overline{{A}_{and}} \cdot \overline{{B}_{and}} ) \cdot ( {A}_{and} \cdot {B}_{and} + \\ {A}_{and} \cdot {B}_{nor} + {A}_{nor} \cdot {B}_{and} + {A}_{nor} \cdot {B}_{nor} ) \\ = ( {C}_{LSP} ⊕ {A}_{and} ⊕ {B}_{and} ) \cdot ( {A}_{and} + {A}_{nor} ) \cdot ( {B}_{and} + {B}_{nor} )\end{matrix}$$

$$\begin{matrix}sign = \overline{{C}_{LSP}} \cdot ( \overline{{A}_{and}} \cdot {A}_{nor} \cdot {B}_{and} \cdot \overline{{B}_{nor}} + {A}_{and} \cdot \overline{{A}_{nor}} \cdot \overline{{B}_{and}} \cdot {B}_{nor} + \\ {A}_{and} \cdot \overline{{A}_{nor}} \cdot {B}_{and} \cdot \overline{{B}_{nor}} ) + {C}_{LSP} \cdot {A}_{and} \cdot \overline{{A}_{nor}} \cdot {B}_{and} \cdot \overline{{B}_{nor}} \\ = \overline{{C}_{LSP}} \cdot ( \overline{{A}_{and}} \cdot {B}_{and} + {A}_{and} ) + {C}_{LSP} \cdot {A}_{and} \cdot {B}_{and} \\ = \overline{{C}_{LSP}} \cdot ( {A}_{and} + {B}_{and} ) + {C}_{LSP} \cdot {A}_{and} \cdot {B}_{and}\end{matrix}$$

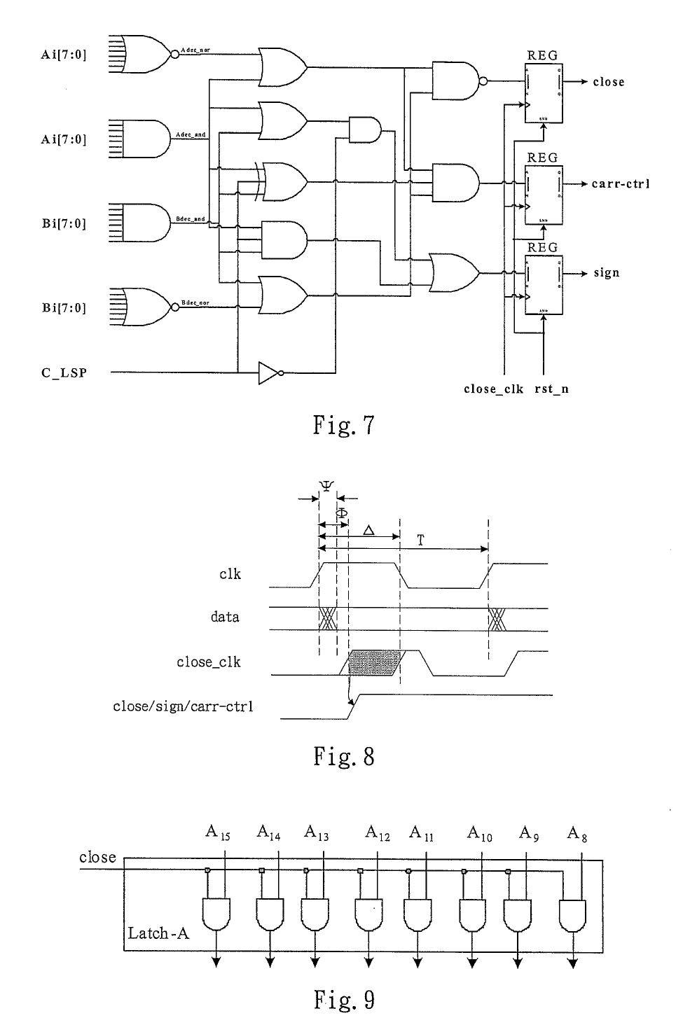

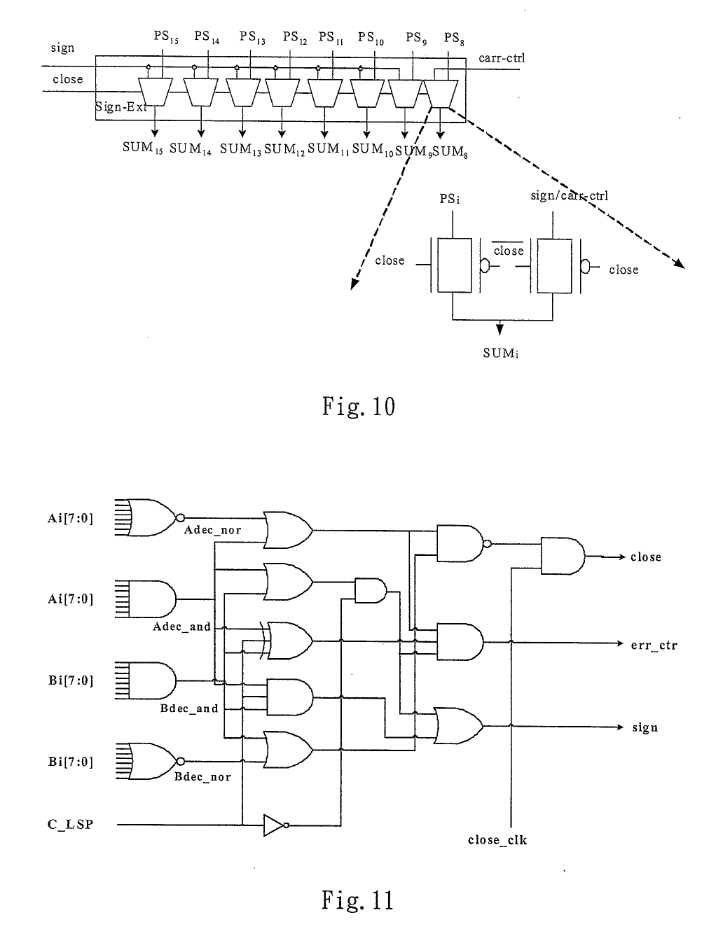

Referring to FIG. 6 for an internal circuit block diagram of a virtual power suppression unit as depicted in FIG. 4, and FIG. 7 for an internal circuit block diagram of a detection logic circuit as depicted in FIG. 6, the SPST adder 7 is divided into a least significant part (A_LSP and B_LSP) circuit and a most significant part (A_MSP and B_MSP) circuit, and uses a detection logic circuit 8 to determine the effective range of data. If the most significant part circuit does not affect the computation result, then the data latches (Latch_A and Latch_B) block the input data of the most significant part circuit, and a sign-extension circuit 9 is adopted to compensate the positive and negative signs of the most significant part of the computation result to provide a correct result. Referring to FIG. 8 for a timing diagram of a detection logic circuit as depicted in FIG. 7, the output of detection logic circuit includes three registers for controlling the timing of three signals: close, carr-ctrl and sign, such that the data latch will be opened to allow data to enter after the data signal is stable, so as to prevent unnecessary power consumption produced during the transient interval Ψ of the arithmetic circuit as shown in FIG. 8. In the meantime, all signals must be in a stable state before the time Δ, and thus the delay time Φ for controlling the timing of the detection logic circuit must satisfy the condition of Ψ<Φ<Δ. Referring to FIG. 9 for an internal circuit block diagram of data latches Latch-A and Latch-B as depicted in FIG. 6, the data larches are composed of at least one AND gate. Referring to FIG. 10 for an internal circuit block diagram of a sign-extension circuit as depicted in FIG. 6, the sign-extension circuit 9 consists of at least one complementary pass-transistor logic circuit.

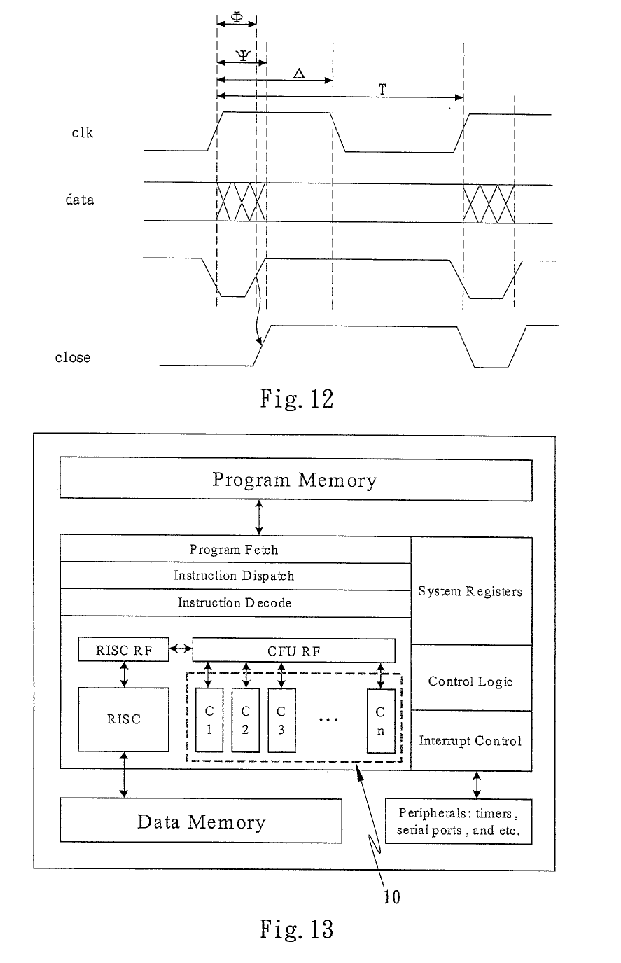

Referring to FIG. 11 for another preferred embodiment of the detection logic circuit in accordance with the present invention, an AND gate is used to replace the register as shown in FIG. 7. Referring to FIG. 12 for a timing diagram as depicted in FIG. 11, a transient signal can be filtered in each clock cycle of the “cclose” signal. Even if Φ<Ψ, the detection logic circuit as shown in FIG. 11 can still operate normally, and this feature can reduce the delay time of the critical path of the circuit system to enhance the performance of the circuit.

Since the video encoding has become a necessary function of various different consumer electronic products, it is an important factor major for microprocessor manufacturers or research and development departments to consider and integrate a video encoding hardware accelerator into a microprocessor, and enhance the processing capability of multimedia applications. A PAC DSP processor having multiple functions and applications and a 5-way VLIW architecture, developed by the System Chip Technology Center of Industrial Technology Research Institute of R.O.C., includes a scalar unit, two cluster instruction executing units and a customized functional unit (CFU), wherein the cluster instruction executing unit includes a data address processor and an arithmetic operation unit, and the CFU is an operating unit designed for special operations. If the PAC DSP processor is applied for multimedia encoding, the arithmetic operation unit and the CFU will be applicable for replacing the technology adopted by the present invention and the circuit design to reduce power consumption. In addition, the TMS320DM641 developed by the a well-known IC manufacturer TI is designed for the digital signal processing required by videoconference and video encoding, and a 256-bit VLIW instruction is used, and eight 32-bit instructions are allocated for eight types of functional units including L1, .S1, .M1, .D1, .L2, .S2, .M2 and D2 within each clock cycle, wherein the two .L and .S functional units are in charge of general arithmetic, logic and branch functions; two .M functional units are in charge of all multiplication operations; and a .D functional unit is in charge of the control of data transmission between a register and a memory. According to the functions, the arithmetic and logic operations performed by the .L and .S functional units and the multiplication performed by the .M functional unit of the DM641 processor can be replaced by the multifunctional design circuit system disclosed by the present invention. Referring to FIG. 13 for a circuit block diagram of a multifunctional video encoding circuit system applied to a processor in accordance with the present invention, a customized functional unit 10 as shown by the dotted line in the figure is composed of a multifunctional video encoding circuit system for performing basic arithmetic operations including addition, subtraction, multiplication and multiply-accumulation, as well as performing an interpolation required for calculating motion compensations in video encoding and a SAD operation required for motion estimations, and the number of customized functional units 10 is determined by the design parameters such as the required performance, hardware cost and power consumption. Microprocessors of this sort including the PAC DSP and the DM641 are key components in the consumer electronic industry. The design of the present invention has two major improvements; the design comes with several operational functions to enhance the flexibility of allocating hardware resources of a microprocessor; and the design adopts the virtual power suppression technology to reduce the dynamic power consumption in a circuit.

In summation of the description above, the present invention provides a multifunctional video encoding circuit system having several computational functions to enhance the flexibility of hardware resource allocation and work with a virtual power suppression unit to reduce the dynamic power consumption in the circuit. The invention herein enhances the performance over the conventional structure and further complies with the patent application requirements and is duly filed for patent application.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multifunctional video encoding circuit system, comprising:
a partial product generation part, that performs a modified booth encoding computation for a plurality of video computing data to generate a plurality of partial product values;
a partial product reduction part, that adds said partial product values to generate a plurality of first results; and
an accumulation part, that accumulates said first results to generate a second result.

2. The multifunctional video encoding circuit system of claim 1, wherein said partial product generation part comprises a virtual power suppression unit, for reducing power consumption of said partial product generation part.

3. The multifunctional video encoding circuit system of claim 1, wherein said partial product reduction part comprises a virtual power suppression unit, for reducing power consumption of said partial product reduction part.

4. The multifunctional video encoding circuit system of claim 1, wherein said accumulation part comprises a virtual power suppression unit, for reducing power consumption of said accumulation part.

5. The multifunctional video encoding circuit system of claim 1, wherein said partial product generation part is a modified booth encoder.

6. The multifunctional video encoding circuit system of claim 1, wherein said multifunctional video encoding circuit system comprises a multiply-accumulate unit, an addition unit, a subtraction unit, a multiplier, an interpolation unit and a sum of absolute difference unit.

7. The multifunctional video encoding circuit system of claim 6, wherein said multiply-accumulate unit, said addition unit, said subtraction unit, said multiplication unit, said interpolation unit and said sum of absolute difference unit are integrated in a computation unit.

8. The multifunctional video encoding circuit system of claim 1, further comprising a plurality of first multiplexers, each for selecting an operation path for said video computing data.

9. The multifunctional video encoding circuit system of claim 4, wherein said accumulation part comprises:
a plurality of data selectors, each for receiving said partial product values;
a plurality of addition circuits, each for receiving said partial product value from said data selector;
an output data selector, coupled with said addition circuits and said virtual power suppression unit, for generating said second result.

10. The multifunctional video encoding circuit system of claim 1, wherein said partial product generation part comprises a plurality of data latches corresponding to a plurality of second multiplexers for latching said second multiplexers.
